(19) United States
(12) Patent Application Publication
(10) Pub. No.: US 2005/0056344 A1
(43) Pub. Date: Mar. 17, 2005

(54) Jig for forming a box joint

(76) Inventor: Paul Freidlund, Rosemount, MN (US)

Correspondence Address: Angenehm Law Firm. Ltd., P.O. Box 48755, Coon Rapids, MN, 55448-0755, US

(21) Appl. No.: 10/662,192

(22) Filed: Sep. 15, 2003

(51) Int. Cl. B27C 5/00

(52) U.S. Cl. 144/144.1; 144/145.1

(57) ABSTRACT

A box joint jig, including a bottom plate; a back plate joined to the bottom plate; and an alignment member the alignment member structured to orient four boards positioned adjacent the bottom plate for a router and a method of forming a box joint, including the steps of mounting four boards in a jig; routing the boards through a groove; routing the boards through additional grooves; dismounting the boards; and joining the corners of the boards interlacing the routes cut in the boards.

### BACKGROUND OF THE INVENTION

The present invention relates to jigs for cutting wood and related products and more specifically to jigs used to form box joints with a router.

Jigs have long been used to make repetitive cutting simpler. In a typical jig, boards or other material to be cut are uniformly laid on a jig and marked or cut at a specific location. For instance studs to be cut to a certain length may all be abutted along a straight edge. A marker of some form may be positioned at the distance away from the straight edge at which the cut is to be made. Without measuring any of the boards, the woodworker knows where to make the cut across all the boards, e.g., at the point of the marker. Jigs in essence remove the need for repeated measuring.

Various complex joints have been proposed and used for joining adjacent corners of furniture. The dove tail, box joint and many other varieties of joints have been developed in this regard. Each type of joint has certain benefits and detriments associated with the joint. Typically, these joints all suffer from complexity of cutting.

Some jigs have been proposed for cutting the box joint. These jigs generally allow only two of the four boards to be cut at the same time. Thus, the woodworker needs to adjust the jig for the first pair of boards, turn the boards over and continue cutting. Then the jig is readjusted and the process of cutting turning and cutting is repeated. If the jig is not set up correctly between the pairs of boards, wood is wasted and the process is continued until the cuts are at the right location. Moreover, these jigs typically have a maximum size of board that can be used with the jig further adding to their limitations.

What is needed is a jig that allows all four boards to be cut simultaneously. The jig should be simple to arrange, preferably mechanical, have manner of aligning the boards which does not require adjustment and be suitable to use with boards of any conceivable length.

### SUMMARY OF THE INVENTION

The present invention is a jig that allows all four boards to be cut simultaneously. The jig is simple to arrange, mechanical, has manner of aligning the boards which does not require adjustment and is suitable to use with boards of any conceivable length.

The box joint jig, includes a bottom plate, a front plate, a back plate, and an alignment member. The bottom plate defines bottom grooves. The front plate, which is joined to the bottom plate, defines front grooves. The front grooves and bottom grooves are in alignment. The back plate is joined to the bottom plate. The back plate defines dust chutes with the dust chutes being aligned with the front grooves and bottom grooves. An alignment member joins either to the back plate or bottom plate. The alignment member structurally orients four boards adjacent the front and back grooves for a router.

The method of forming a box joint may include the steps of mounting four boards in a jig; routing the boards through a groove; routing the boards through additional grooves; dismounting the boards; and joining the corners of the boards interlacing the routes cut in the boards.

Advantageously, the present invention allows routing of all four boards to form box joints between the boards.

Also advantageously, the present invention provides for alignment of the boards such that the router may be moved in a straight line from one board to the next and route the boards at the correct location.

As yet a further advantage, the present invention provides a mechanism for properly aligning the boards for routing with the boards being of unlimited length.

As still another advantage, the present invention is usable with any router table, avoiding the need for additional power tools.

These and other advantages will be made clear from the detailed description below.

### DESCRIPTION OF THE DRAWINGS

FIG. 1 is an exploded top view of the present invention with boards shown in phantom;

FIG. 2 is a bottom view of the present invention;

FIG. 3 is an exploded front view of the present invention;

FIG. 4 is a back view of the present invention;

FIG. 5 is a right side view of the present invention with boards shown in phantom;

FIG. 6 is a left side view of the present invention with boards shown in phantom;

FIG. 7 is a perspective view of a box joint;

FIG. 8 is an exploded view of an adapter with a router bit;

FIG. 9 is a top view of the adapter; and

FIG. 10 is a side view of a bottom alignment member.

### DETAILED DESCRIPTION

The box joint jig 10 may include a bottom plate 20, a front plate 30, a back plate 40, a back alignment member 60, a bottom alignment member 80, a router bit 90 and an adapter 92. The jig 10 is used for forming box joints 14 as shown in FIG. 7. The jig 10 simultaneously orients four boards 12 and guides the router bit 90 such that the router bit 90 cuts the routes 16 for all four boards 12 in a single sweep. These components are discussed in serial fashion below.

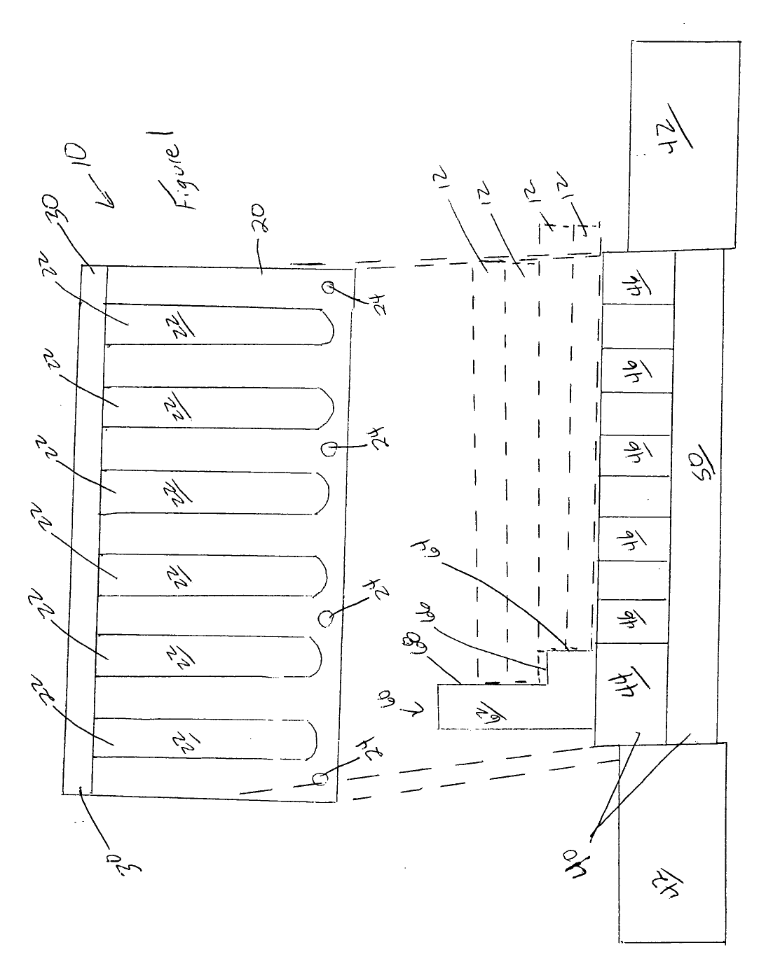

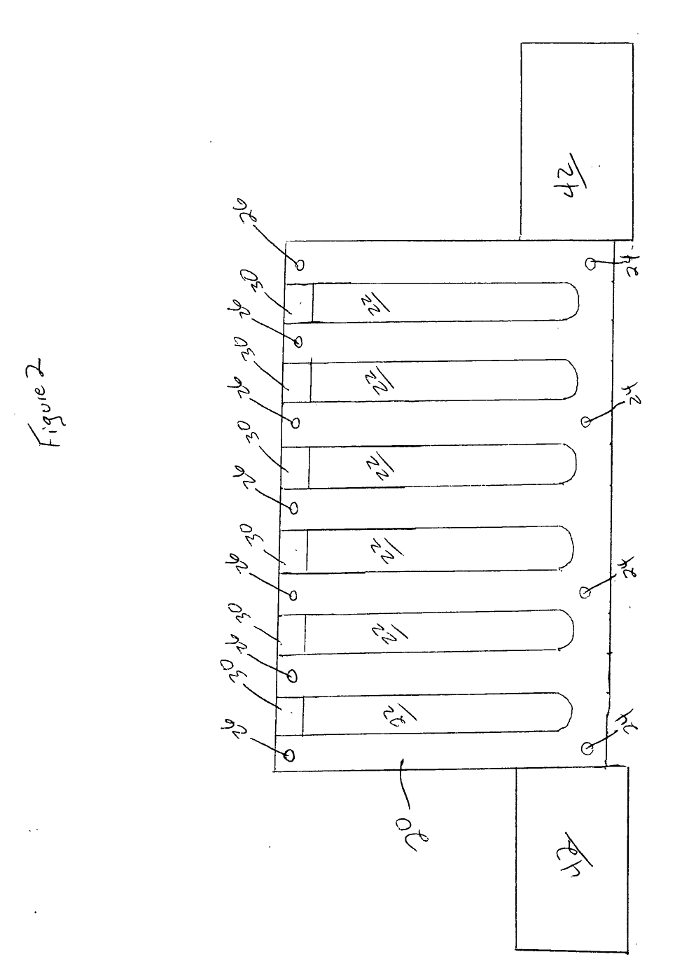

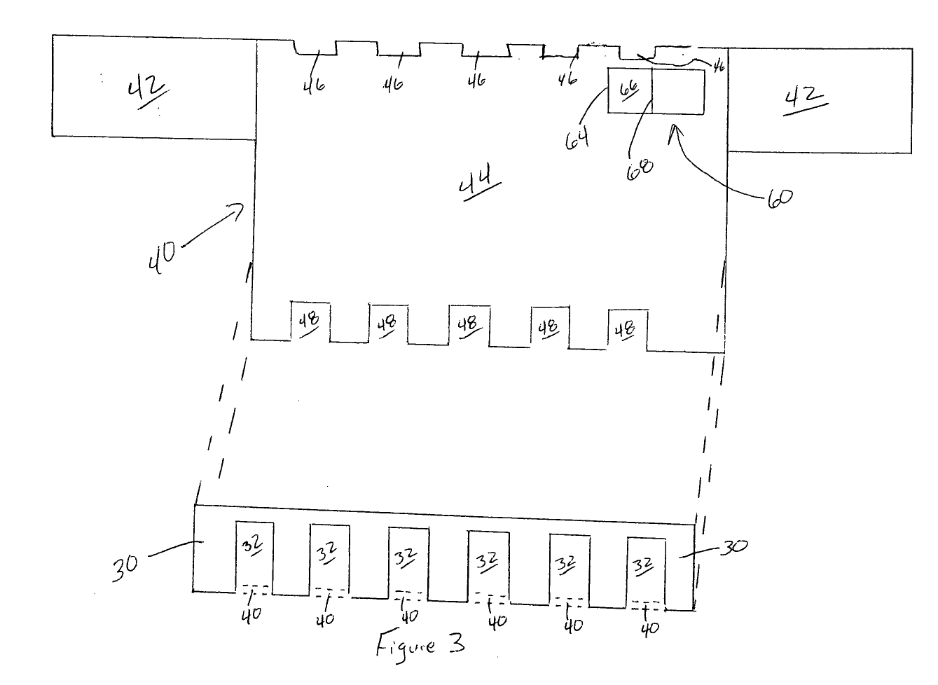

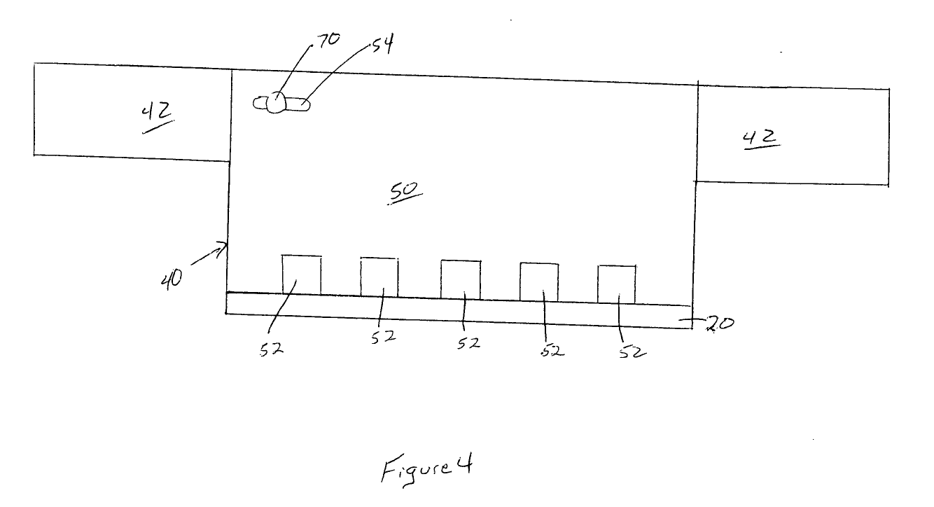

The bottom plate 20 may be joined to the front plate 30 and back plate 40. (See FIGS. 1 and 2). The plates 20, 30 and 40 may be joined with fasteners 24 and 26 respectively, may be cast, molded or otherwise formed integrally, or may be joined in any other manner known in the art. The bottom plate 20 defines grooves 22, which extend through the bottom plate 20 and provide access for the router bit to boards 12 positioned atop the bottom plate 20.

The bottom plate 20 may be interchangable with other bottom plates 20. The purpose of interchangability is to allow the jig 10 to be used with different widths of router bits 90. The width of the bottom grooves 22 in part dictate the width of routes 16 that may be cut into a board. Varying the width of the bottom grooves 22, allows the routes to be placed closer together, e.g. smaller width of router bits 90, or farther apart, e.g. wider width of router bits 90.

The front plate 30 preferably is joined to the bottom plate 20. The front plate 30 defines front grooves 32 with the front grooves 32 being in alignment with the bottom grooves 22. The front plate 30 cradles the boards 12 when being placed into the trough area defined by the front plate 30, back plate 40 and bottom plate 20, preventing boards 12 from inadvertently sliding off the jig 10.

The back plate 40 preferably is joined to the bottom plate 20. The back plate 40 in combination with the bottom plate 20 defines dust chutes 52. The dust chutes 52 are aligned with the front grooves 32 and bottom grooves 22, allowing recently cut saw dust to exist through the back of the jig 10. Handles 42 preferably are joined to the back plate 40, such that the wood worker, guiding the jig 10 on a router table, has a manner to grip the jig 10 where their hands are away from the router bit 90. The back plate 40 may include a guide board 44 and a back support 50. The guide board 44 defines grooves 48, which are in alignment with the front grooves 32, bottom grooves 22, and dust chutes 52. The guide board 44 may have visual guide grooves 46 that allow the wood worker to visually sight where the routes 16 will be cut on the opposite edge of the boards 12. The back plate 40 may define an alignment aperture 54 discussed more fully with regard to the back alignment member 60.

The alignment member may be structured to orient four boards 12 positioned adjacent the bottom plate 20 for simultaneous routing. The alignment member may be a back alignment member 60 or a bottom alignment member 80. The alignment member is structured to orient four boards 12, in two offset pairs, adjacent the front and bottom grooves 32, 42 for a router. That is, each alignment member holds the boards 12 in a position such that all four boards of a box may be simultaneously routed in a position that allows the boards to be joined to each other in a box joint.

The back alignment member 60 is joined to the back plate 40. A block 62, with an extended wall 64, a connecting wall 66 and an inset wall 68, may be joined with a fastener extending through the alignment aperture 54 to the back plate 40. The extended wall 64 is positioned to offset two boards 12 from two boards 12 biased against the inset wall an amount equal to the width of the route 16. In this manner, the routes 16 on two boards 12 will be positioned on the unrouted parts 18 of the other two boards 12 and vice versa. That is, the routes 16 and unrouted parts 18 are perfectly positioned on all four boards 12 to interlock as shown in FIG. 7. The connecting wall 66 is of the same width as the width of the router bit 90 and may corresponds to the width of the bottom grooves 22 in accordance with the discussion below concerning the groove engagement segment 98 of the adapter 92.

The alignment member may be a bottom alignment member 80. The bottom alignment member 80, includes a base 82, a groove engagement segment 84 and a route engagement segment 86. The base 82, groove engagement segment 84 and route engagement segment 86 are joined to each other as shown in FIG. 10. The base 82 is positionable under the bottom plate 20. The groove engagement segment 84 is sized to be snugly received in the bottom grooves 22 such that route engagement segment 86 is positioned in the path where the router bit 90 traveled. The route engagement segment 86 is sized to be snugly received within a route 16 of at least one board 12. If the route engagement segment 86 does not engage all boards 12, the boards may be held in alignment relative to each other with any clamp, known in the art of woodworking, secured to the boards 12. The back alignment member 60 is generally removed from the back plate 20 when the bottom alignment member 80 is in use.

The bottom alignment member 80 allows boards 12 of indefinite length to be routed with jig 10. The user simply routes through all the bottom grooves 22, using the back alignment member 60 and removes the back alignment member 60. Thereafter, the boards 12 are slid through the trough, defined between the front plate 30, back plate 40 and bottom plate 20, lining up a bottom groove 22 with a route 16. The bottom alignment member 80 engages the route 16 holding all the boards 12 in position over the bottom grooves 22 for additional routing. Longer boards 12 require additional sliding of the board 12 through the trough and re-connection of the bottom alignment member 80 in a route 16.

The adapter 92 may serve to guide the router bit 90 through the front grooves 32 and bottom grooves 22. The adapter 92 may including a ring 94, a body 96, threading 98 and a groove engagement segment 100. The ring 94 serves as a force opposing at least a portion of the body 96 to secure the adapter 92 to a router table. The ring 94 connects to the threading 98 and in combination tightens the body 96 to the table. The groove engagement segment 100 is sized to be snugly received in the front grooves 32 and bottom grooves 22 such that the router bit 90 is guided in a straight line along the length of the bottom grooves 22. The router bit 90 extends through the adapter 92 out through an opening 102 in the groove engagement segment 100.

In operation a box joint 14 is formed with the steps of mounting four boards 12 in a jig 10; routing the boards 12 through a groove 22; routing the boards 12 through additional grooves 22 until routes 16 have been cut along the entire length of two opposing edges of all four boards 12; dismounting the boards 12; and joining the corners of the boards 12 interlacing the routes 16 cut in the boards 12. The four boards 12 may be simultaneously aligned with either a back alignment member 60 or a bottom alignment member 80, generally starting with the back alignment member 60.

Although the present invention has been described with reference to preferred embodiments, workers skilled in the art will recognize changes may be made in form and detail without departing from the spirit and scope of the invention.

1. A box joint jig, comprising:
a bottom plate;
a back plate joined to the bottom plate; and
an alignment member the alignment member structured to orient four boards positioned adjacent the bottom plate for contiguous routing such that the routes on the four boards are positioned to interact forming box joints.

2. A box joint jig, comprising:
a bottom plate, the bottom plate defining bottom grooves;
a front plate joined to the bottom plate, the front plate defining front grooves, wherein the front grooves and bottom grooves are in alignment;
a back plate joined to the bottom plate; and
an alignment member structured to orient four boards adjacent the front and back grooves for a router to cut both sides of a box joint in one cut.

3. The device of claim 2 wherein the bottom plate is fastened to the back plate.

4. The device of claim 2 wherein the bottom plate is fastened to the front plate.

5. The device of claim 2 further comprising handles joined to the back plate.

6. The device of claim 2 wherein the back plate further comprises a guide board, the guide board including visual guides.

7. The device of claim 2 wherein the back plate further comprises an alignment aperture defined through the back plate.

8. The device of claim 7 wherein the alignment member further comprises a fastener and a block, the fastener extending through the alignment aperture and joining to the block.

9. The device of claim 2 wherein the alignment member is a back alignment member.

10. The device of claim 2 wherein the alignment member is a bottom alignment member.

11. The device of claim 2 wherein the alignment member further comprises a groove engagement segment and a route engagement segment.

12. The device of claim 11 wherein the groove engagement segment of the bottom alignment member is sized to be snugly received within the bottom groove.

13. the device of claim 11 wherein the route engagement segment is sized to be snugly received within a route defined in a board.

14. The device of claim 2 further comprising an adapter, the adapter including a groove engagement segment, and the adapted being structured to operably communicate a router bit with boards disposed on the bottom plate.

15. The device of claim 11 wherein the groove engagement segment of the adapter is sized to be snugly received within the bottom groove.

16. The device of claim 2 further comprising at least one board.

17. The device of claim 16 wherein the at least one board is clamped to the back plate.

18. The device of claim 2 wherein the alignment member is removable.

19. A method of forming a box joint, comprising the steps of:
mounting four boards in a jig;
routing the boards through a groove;
routing the boards through additional grooves until opposing edges of both sides of each board have routes disposed along the entire length thereof;
dismounting the boards; and
joining the corners of the boards interlacing the routes cut in the boards.

20. The method of claim 19 further comprising the step of:
using a back alignment member; and
switching the back alignment member with a bottom alignment member to complete the routing of the boards.
